(19) United States
(12) Patent Application Publication
(10) Pub. No.: US 2010/0108054 A1
(43) Pub. Date: May 6, 2010

(54) OPTICALLY EFFICIENT AND THERMALLY PROTECTED SOLAR HEATING APPARATUS AND METHOD

(76) Inventors: Donald L. Ekhoff, Morgan Hill, CA (US); Gregory Toker, Jerusalem (IL)

Correspondence Address: MITCH HARRIS, LLC - GENERAL, P.O. BOX 7998, ATHENS, GA, 30604, US

(21) Appl. No.: 12/265,780

(22) Filed: Nov. 6, 2008

(51) Int. Cl. F24J 2/24; F24J 2/10; B23P 15/26; F24J 2/00

(52) U.S. Cl. 126/655; 126/684; 29/890.033; 126/714

(57) ABSTRACT

An optically efficient and thermally stable solar heating apparatus and method provide efficient heating by using a solar collector having a transparent tube containing a porous absorbent material or structure that permits liquid or aerosol to percolate through the transparent tube. Thermal protection against overheating is provided when the system is drained by a transparent top with a bottom surface that, when in contact with another liquid medium filling the collector, permits incident light to enter and be collected, but when the liquid medium that normally contacts the bottom surface of the top is absent when the system is drained, incident light is reflected. The collector, top and transparent tubes may be extruded and made from the same recyclable plastic material, making the assembly lightweight for installation and ease of structural integration, while facilitating recyclability of the entire collector.

### BACKGROUND OF THE INVENTION

1. Field of the Invention

The present invention relates generally to solar heating devices and methods, and more particularly, to an optically efficient solar heater that is thermally protected.

2. Description of the Related Art

Solar heaters for heating water or other liquids or aerosols are useful for heating water for providing building heating, hot tap water supply, swimming pool heating and other uses such as providing heat for thermo-chemical reactions.

A common form of solar heater uses a stationary connected system of pipes, without solar tracking. The pipes are attached to an optically absorbent (black) backing, which is typically thermally isolated from the mounting structure to which it is attached, typically by a thermal insulator provided beneath the backing. The system of pipes contains a liquid medium, typically water, which is heated by direct solar radiation. The system is covered by a glazing glass window, which is optically transparent in the visible spectrum, but is opaque to thermal infrared radiation that is emitted by the heated absorber. The presence of the glazing glass and insulator permit the liquid in the system to reach thermal equilibrium at a much higher temperature than would be possible with a set of pipes in open air.

However, there are several disadvantages to the typical solar heater described above. First, no solar concentration is employed, which makes the heating process slow, reduces the usable “Sun time”, and reduces the achievable liquid temperature. In water heating applications, the lower the output water temperature, the less the available hot water capacity, since less cold water can be mixed with the heated water during use. Therefore, large water tanks are required to store heated liquid, approaching 100% of the maximum demand amount for systems designed to provide as much hot water as possible at the end of the available “Sun time.”

Second, the piping system and the absorber form a large linked thermal mass, and therefore the thermal response time of the liquid medium to the onset of a solar radiation cycle is slow, causing additional loss of available “Sun time.” Also, the hot portion of the system—the piping system and the absorber—has a large surface area, which increases system losses. Third, while no overheating protection is necessary for typical non-concentrating solar heating systems, such systems are susceptible to damage in freezing conditions, typically requiring preventative draining of the system during cold weather conditions, or making the system more complicated and less efficient by separating the exposed heating loop from the main water supply by using a heat exchanger and filling the exposed heating loop with an anti-freeze liquid mixture.

Fourth, the typical solar heating system has significant weight, raising structural support and installation issues. The above-described solar water heaters are typically heavy and installed in large sections, making installation difficult for a solitary installer or homeowner. Finally, typical collectors are fabricated from large quantities of expensive metals (e.g., copper) that are heavy, difficult to recycle, and involve carbon dioxide emission in their manufacture.

Therefore, it would be desirable to provide a more efficient stationary solar heating system, with a fast heating response and elevated water temperature. It would further be desirable to provide such a solar heating system that is lightweight, has low manufacturing and installation cost, which is protected against freezing and overheating, and which has a lowered environmental impact.

### SUMMARY OF THE INVENTION

The objective of providing an efficient, lightweight, thermally protected solar heating system having low manufacturing and installation cost, and which has lowered environmental impact, is provided in a solar heater apparatus and method of heating a first liquid or aerosol medium. The method is a method of manufacturing the solar heater.

The solar heater comprises a stationary concentrating light collector including transparent tubes through which a liquid or aerosol flows and is heated. The light collector has multiple parallel concave reflector sections each for containing one of the tubes, and the tubes are interconnected via manifolds at each end. The collector is closed by a transparent top and on the ends by end walls, which may incorporate the manifolds. The top may be formed in two separate layers, providing an insulating air gap between the layers, with the topmost layer serving as glazing. Similarly, side walls may be formed having an air gap to insulate the sides of the final assembly.

The transparent tubes contain an absorbing material or structure through which the first liquid or aerosol is permitted to flow. The absorbing material may also form a catalytic surface for enhancing a reaction between substances in the first liquid or aerosol medium. Under normal heating conditions, the concentrating light collector is completely filled with a second liquid, which may be of the same composition as the medium in the tubes.

The collector, the tubes, the top, the side walls and air gap can be extruded as a single recyclable transparent plastic unit forming multiple parallel collector reflectors, which are coated from the back (bottom surface) of the collector portion to form the reflective collector. Similarly, end walls forming the manifolds can be extruded as whole units. The tubes can be filled with a granular absorbing material, or an absorbing structure or sponge-like absorbing material inserted into the tubes during the assembly process. Extruding most or all of the solar heater from the same recyclable plastic material simplifies both manufacture and recycling of the system components. A bottom panel may be made from the same material as the collector, and attached to the bottom and side walls to form a complete thermally insulating housing.

The top may include a bottom (inside) surface that is shaped and has a refractive index greater than that of air, such that when reflective collector is completely filled with the second liquid medium, incident light is transmitted through the top, but when the liquid is not in contact with the bottom surface of the top, incident light is reflected. Thus, in order to prevent damage due to overheating in extreme temperature conditions, the second liquid inside the collector may be at least partially drained, preventing most or all of the incident light from reaching the transparent tubes. The draining process may be initiated manually or performed automatically in response to a thermal sensor built into the system. The shaped top can be manufactured in the same single extrusion process described above.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIGS. 1A-1B are an end view and an isometric view, respectively, of a solar collector unit in accordance with an embodiment of the invention.

FIG. 2 is a partial sectional view of the solar collector of FIGS. 1A-1B.

FIG. 3A-3C are a side view, an end view and an isometric view, respectively, of a manifold 30 in accordance with an embodiment of the invention that can be attached to the ends of the solar collector of FIGS. 1A-1B.

FIGS. 4A-4B are a partial sectional view and a partial top view, respectively, showing details of a completely assembled solar heater in accordance with an embodiment of the invention.

FIGS. 5A and 5B are pictorial drawings illustrating the thermally protective action of transparent top 17 of FIGS. 1A-1B, 2, and 4A-4B.

FIGS. 6A and FIG. 6B are pictorial drawings illustrating a shape of transparent tubes 14 of 1A-1B, 2, and 4A-4B during normal operating conditions and during a freezing condition, respectively.

### DESCRIPTION OF ILLUSTRATIVE EMBODIMENT

The present invention encompasses solar heating systems that employ concentrating reflective collectors to provide high efficiency over a wide collection angle and that provide thermal protection by using flexible (elastic) structures and by providing a top that is substantially reflective when a second liquid medium that normally fills the space between the top and the reflective collector surface is drained or otherwise displaced by a gas. Heating of a first liquid or aerosol medium is provided by flowing the first liquid or aerosol medium through a transparent tube containing a porous absorbing material or structure. The medium being heated may be a liquid, such as water, or an aerosol, such as a chemical mixture that reacts under thermal agitation. The absorbing material may be coated with a catalytic surface, enhancing a reaction between substances in the first liquid or aerosol medium.

Since the second liquid medium has a refractive index greater than that of air, the interface between the air and the second liquid medium “bends” incident light rays towards the angle normal to the interface, providing concentration for the full angular range of light receivable by the aperture formed by the top of the collector (i.e., substantially 180 degrees), including direct light at the beginning and end of the “Sun time”, as well as collecting diffuse light that reaches the aperture, such as light reflected from clouds. The concentration ratio of such a system is equal to the refractive index of the second liquid medium, which is sufficient to considerably improve the solar heating system's efficiency by elevating the temperature of the heated medium.

The present invention also encompasses solar heating systems that employ a solar collector that is extruded as a single piece, including reflective collector(s) and a transparent top. Optionally, the tubes through which the medium to be heated is conducted, a top glazing cover forming an air gap above the transparent top, and side panels including air gap channels may also be formed in the same single extrusion. Manifolds for attachment at ends of the collector unit can also be extruded or molded from the same material, providing simplicity of manufacture, thermal/chemical compatibility of materials, and ease of recycling. The manifolds may be glued, ultrasonically welded, or attached in another suitable manner to provide a liquid-tight seal. The attachment may be performed at the time of manufacture, or on-site during installation. The plastic material employed in the extrusion is generally an elastic material, such as LEXAN or APEC, rather than other more brittle plastics or other materials such as glass. The collector assembly is also extruded as a thin-wall structure, so that under internal or external pressure, such as will occur during freezing, the assembly changes shape but does not fracture. Moreover, when the internal or external pressure is removed, the collector assembly will recover its original shape. As such, the plastic collector assembly is highly resilient and can be certified for use in outside walls, windows and tiles in weather conditions including hurricane level forces.

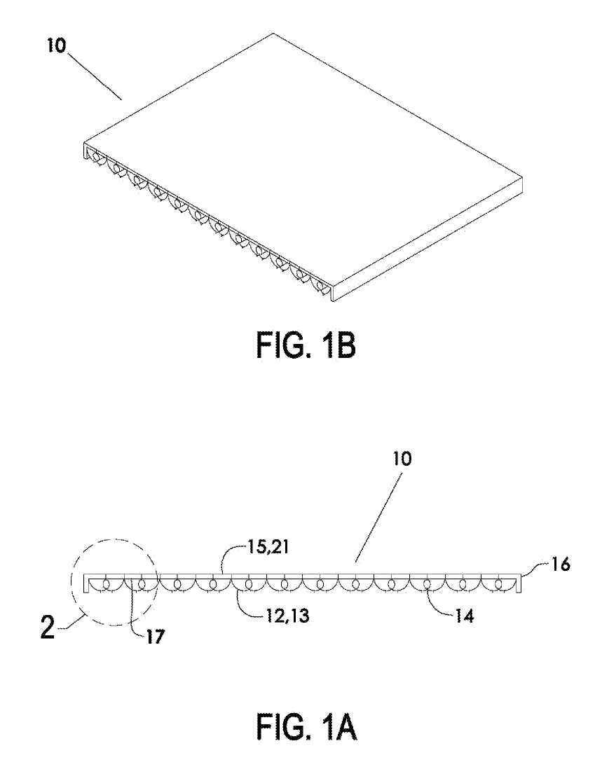

Referring now to FIGS. 1A-1B, a solar heating collector unit 10 in accordance with an embodiment of the present invention is shown. A number of transparent tubes 14, in which the first liquid or aerosol medium flows and is heated, terminate on the ends of collector unit 10. Transparent tubes 14 are disposed within corresponding collector channels 12 within collector unit 10, which can be extruded as a single thin-walled polymeric structure and then back-coated to provide a reflective surface 13 on the bottom side of collector channels 12. Alternatively, the reflective surface may be formed on either side of, or internal to the material forming collector channels 12, or collector channels may be made of a reflective material in embodiments in which a single extrusion of collector unit 10 is not performed. A top cover 15 of collector unit 10 includes an air gap channel 16 formed between a liquid-retaining top 17 of collector channels 12, and an outer top surface 21 of collector unit 10. Air gap channel 16 provides thermal insulation for the outer top surface 21 of collector unit and outer top surface 21 serves as a glazing surface.

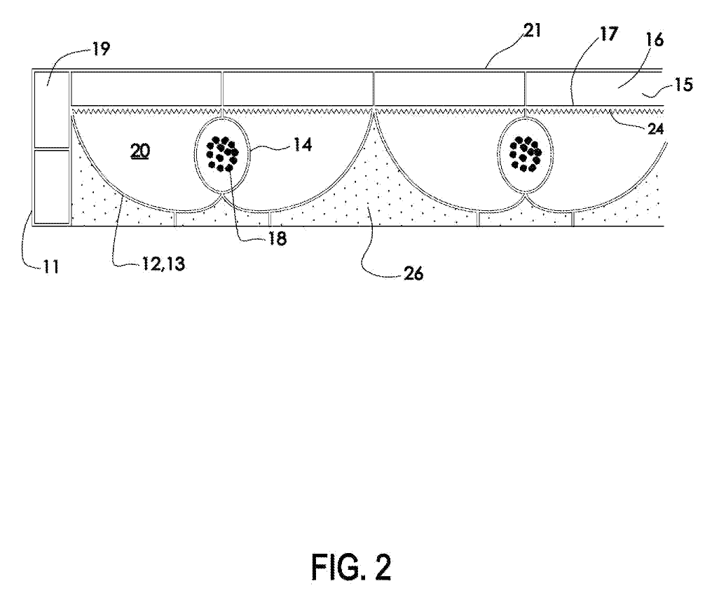

Referring now to FIG. 2, details of collector unit 10 of FIG. 1B are shown in cross-section. In addition to the air gaps provided between liquid-retaining top 17 and outer top surface 21, side walls 11 also include air gap channels 19 to provide thermal insulation at the sides of collector unit 10. Transparent tubes 14 are elliptical in cross section, rather than circular. If pressure increases within transparent tubes 14 due to boiling or other overpressure condition, transparent tubes 14 will deform to become more circular, preventing transparent tubes 14 from bursting. Further, if a second liquid 20 disposed within collector channels 12 freezes, then transparent tubes 14 accommodate the increased external pressure by flattening (i.e., becoming more elliptical), which provides protection against uncontrolled deformation and cracking that would otherwise be caused in more rigid tubes of circular cross-section that are commonly used in solar water heating systems. Similarly, collecting channels 12, as well as the liquid-retaining top 17, top cover 15, and side walls 11, due to their thin-wall structure, will also deform rather than crack or burst under such conditions.

Transparent tubes 14 contain an absorbing material or structure 18 that absorbs light, whether directly incident on transparent tubes 14 or reflected by reflective surface 13 of collector channels 12. The light striking absorbing material 18 is converted to thermal energy by absorption. Absorbing material or structure 18, which may be composed of granules, fins, threads or a sponge-like porous material, allows the first liquid or aerosol medium to flow or percolate through absorbing material or structure (absorber) 18, and provides a large effective surface area with respect to the incident light due to multiple reflections within absorber 18. Absorber 18 may be extruded out of a thermally-conductive light-absorbing plastic material having a profile with fins and through holes for passing the liquid or aerosol medium, and cut into small segments of the extrusion. The material may have a density close to that of a liquid medium, so that the segments will float in the liquid medium, allowing absorber 18 to readily adapt to changes in the shape of transparent tubes 14 under differing pressure conditions. Absorber 18 provides a large contact area with the first liquid or aerosol medium for efficient heat transfer, while providing a relatively small outer surface area via which thermal energy is radiated outward.

Collector unit 10 is supported, and is thermally isolated on the bottom side of collector unit 10, by a bottom insulator 26, which may be foam layer, air gap or other suitable thermally-insulating structure disposed around the bottoms of collector channels 12, and that provides sufficient structural support for collector unit 10 when collector channels 12 are filled with second liquid medium 20. Thermally isolating air gap channel 16, side air gap channels 19, and bottom insulator 26 reduce thermal losses from the system by thermally isolating the warmer portions of collector unit 10 from their surroundings.

Transparent tubes 14 can be filled with absorbing material either during manufacture or installation, generally on a building rooftop. Mesh plugs may be inserted to retain granular absorber 18, which may be provided in bags for on-site assembly, to provide for lightweight transport of the system components to the point of installation. Alternatively, manifold structures as described below may incorporate perforations or plugs that retain absorber 18. Liquid-retaining top 17 of collecting unit 10 includes a structured bottom surface 24 that causes liquid-retaining top 17 to re-direct incident light to the outside of collecting unit 10 when second liquid medium 20 is drained or otherwise displaced by gas. Such draining can be automatically performed by opening an appropriately-placed thermal valve if the system is overheated, which may occur during conditions of extreme external temperatures during full sun and low flow conditions. By re-directing incident light outside of collecting unit 10, an effective shutdown of the heating action is accomplished, which provides automatic overheat protection. Once the overheat conditions cease to exist, the thermal valve shuts, collector channels 12 are refilled with second liquid medium 20, and normal heating operation is thereby resumed.

Incident light is collected by collector channels 12, which act as concentrators to direct all incident light into a region occupied by transparent tubes 14. U.S. Pat. No. 4,002,499 to Winston, incorporated herein by reference, describes the design of a reflective concentrator suitable for use as concentrator channels 12. However, in the present embodiment, the size of transparent tube 14 is made larger by a factor of approximately 10% from the optimal reflector design described by Winston, as such increase provides that light rays reaching transparent tube 14 will not be at grazing incidence at the tube perimeter, and therefore will better penetrate transparent tube 14, reaching absorber 18. As a result, a small sacrifice concentration ratio, an approximately 10% reduction, provides for a greater efficiency of light absorption, and since high concentration rations are not generally needed for applications such as solar water heating, the increase in size of transparent tube 14 provides superior operation.

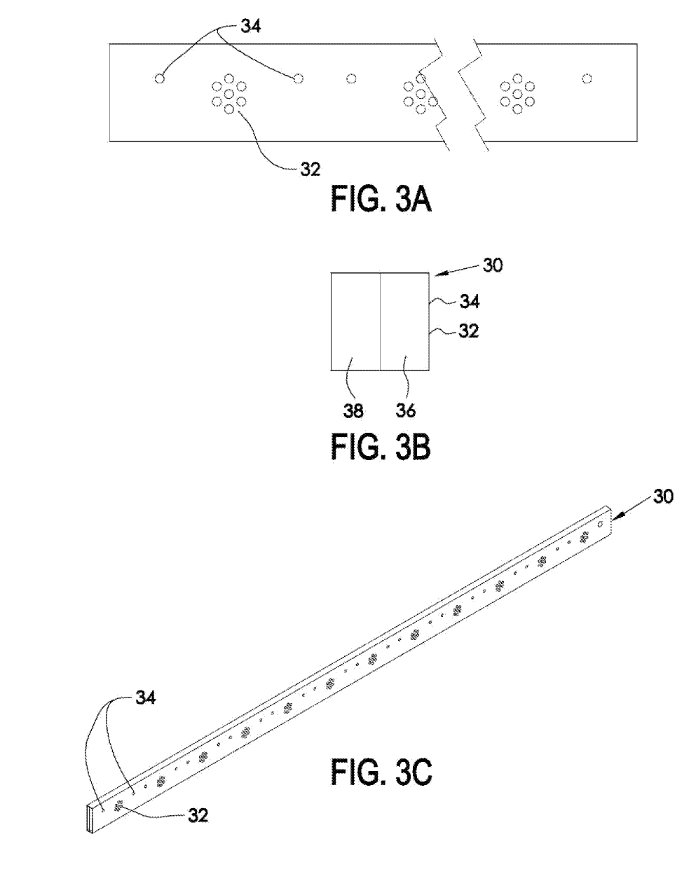

Referring now to FIGS. 3A-3C, details of a pair manifolds 30, one for each end of collector unit 10, are shown. Manifolds 30, serve as end walls for collector unit 10, as well as providing the manifold function, and are generally extruded or molded from the same material as collector unit 10. Manifold 30 has two chambers, a manifold chamber 36 and an air-gap chamber 38. The outer wall of manifold 30 that abuts collector unit 10 in the final assembly is perforated to provide for flow of both the first liquid/aerosol medium and second liquid medium 20 into/from manifold chamber 30. Hole pattern 32 abuts the ends of transparent tubes 14 and acts as a mesh to retain absorber 18 if needed (e.g., if absorber 18 is a granular material), while hole pattern 34 aligns with the upper portion of collectors 12 to provide for introduction and drainage of second liquid medium 20.

Since, for overheat protection, drainage of second liquid medium 20 is only required to the degree that removes contact between second liquid medium 20 and structured bottom surface 24, and further, since collector unit 10 will generally be installed at an inclination away from horizontal and drained from its lower end, the placement of hole pattern 34 is not critical, and drainage of even a small amount of second liquid medium 20 will provide thermal protection. In one particular embodiment of the invention, second liquid medium 20 is the same medium as the first (liquid) medium, which are both water being heated by the system, and the two media are allowed to communicate with each other in a common manifold chamber. Because of the directional flow of water through the system and the size of the holes in hole patterns 32,34, little intermixing occurs between second liquid medium 20 and the first liquid medium. It is noted that when second liquid medium is a different material from the first liquid/aerosol medium, then two separate manifold chambers 36 will generally be required to align with hole patterns 32,34 and therefore hole patterns 32,34 will generally have different placements in such embodiments of the invention that provide communication with each of hole patterns 32,34 with corresponding separate manifold chambers. Even in embodiments in which second liquid medium 20 and the first medium are the same, separate manifold chambers 36 for each medium can be provided to further improve the efficiency of the system.

In the embodiment of the invention including manifolds as depicted in FIG. 3A-3C, second liquid medium 20 is the same tap water as the first liquid medium. During overheating conditions, the thermal valves will disconnect the system from the main water supply and open outlets connected to the manifold, emptying collector channels 12, and thereby shutting down the heating action. When the overheating condition ceases, the thermal valves close the drain and reconnect the system to the water supply, automatically filling the collectors with water and resuming normal function.

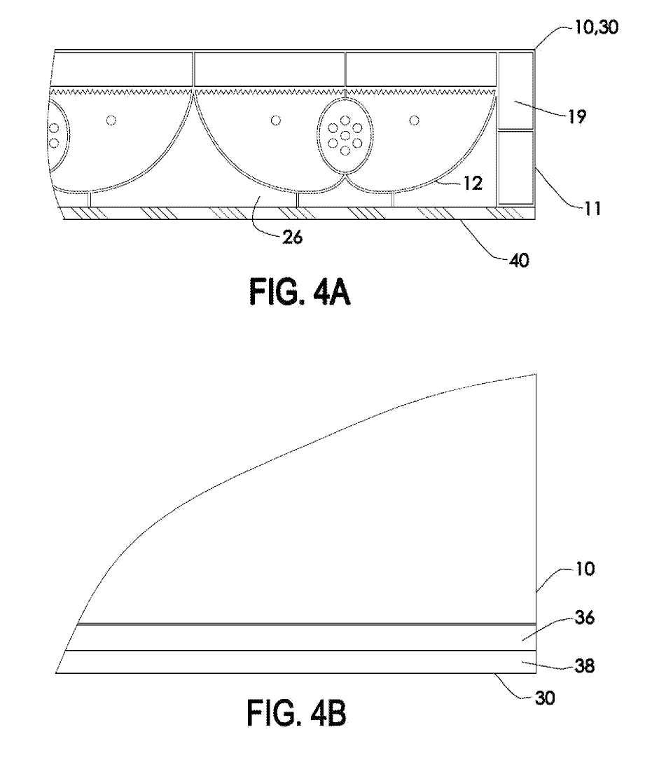

Referring now to FIGS. 4A-4B, details of a portion of a completed solar heater assembly are shown in accordance with an embodiment of the invention. A bottom plate 40 and insulating foam 26 are added beneath collector unit 10. Manifold 30 has been attached to an end of collector unit 10 as illustrated by the top view of FIG. 4B (and similarly another manifold 30 has been attached to the other end that is not visible in the Figure). As shown, collector unit 10 includes side panels 19 providing air gaps 11, which in combination with the top air gap channel, provide a rigid thermally-insulating outer housing. Side channels are constructed as hollow structures providing thermal insulation without adding significant weight. As an alternative, bottom plate 40, in combination with additional structural support members (e.g., vertical struts) provided on the bottom side of collector channels 12 or extending upward from bottom plate 40, can be attached without including insulating foam 26 and can provide thermal isolation via the air gap formed between bottom plate 40 and the bottoms of collector channels 12.

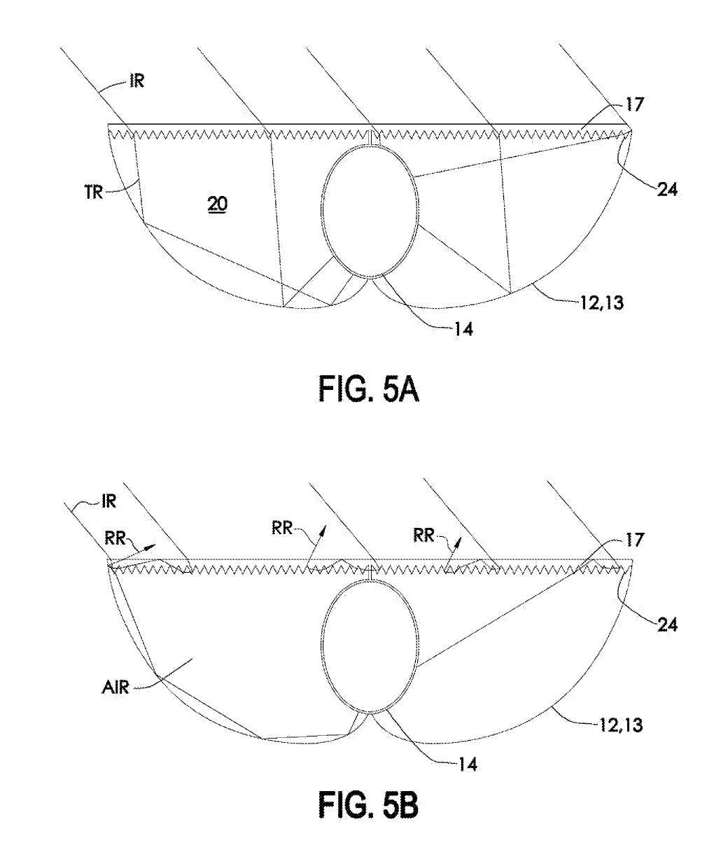

Referring now to FIGS. 5A and 5B, operation of structured bottom surface 24 of transparent top 17 of collector channels 12 is illustrated. FIG. 5A illustrates paths of incident rays IR when second liquid medium 20 completely fills the volume between structured bottom surface 24 and the bottom of collector channels 12. FIG. 5B illustrates operation of structured bottom surface 24 when collector channel 12 is drained of second liquid medium 20 and replaced by air (or another gas). In FIG. 5B, the difference between the refractive indices at the interface is large and incident rays IR experience total internal reflection on the inclined features of structured bottom surface 24. Most of incident rays IR are re-directed along and among the features of structured bottom surface 24 and are eventually emitted out of collector unit 10, and therefore never reach transparent tube 14.

It is noted that second liquid medium 20 need not be completely drained in order for collector 10 to become reflective. It is sufficient that a small air or water vapor gap is present between structured bottom surface 24 and the top surface of second liquid medium 20. Structured bottom surface 24 provides a wider angle of shut-down operation than other structures such as retro-reflectors that operate over a very narrow angular range (e.g., 10 degrees). Using triangular shapes as depicted, with the faces of the triangular shapes inclined substantially 62 degrees to the left or the right from the primary plane of transparent top 17 (i.e., the bottom vertex of the triangles is substantially equal to 56 degrees), most of incident rays IR within a total angle of approximately 70 degrees are directed out of collector 10, which is sufficient to provide thermal protection for a solar water heater.

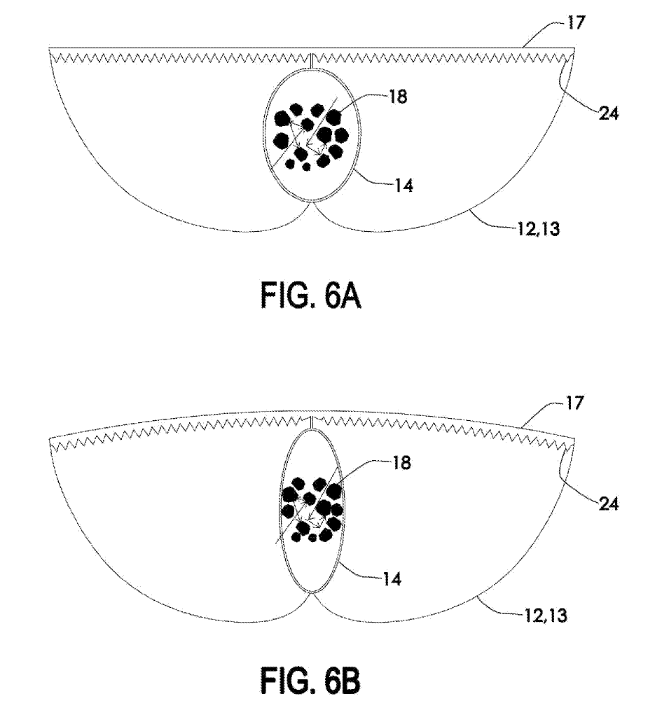

Referring now to FIGS. 6A and 6B, absorbing material 18 within transparent tubes 14 is shown. In FIG. 6A, transparent tube 14 has a slightly elliptical shape, approximately 10-20% at nominal pressure, but in FIG. 6B, transparent tube 14 has a further distorted shape due to pressure, which will occur when water outside of transparent tubes 14 has frozen. Side walls 19, transparent top 17 and cover 15 may also be bent slightly, but not to the point of permanent deformation. Under high internal pressure conditions, such as due to boiling or line over-pressure conditions, the shape of transparent tubes 14 becomes more circular, absorbing the additional stress without bursting. Due to the elastic properties of the selected material, a nominal shape will be recovered after any freezing or over-pressure conditions are removed.

As illustrated in FIG. 6A by the arrows, light entering transparent tubes 14 is effectively trapped by absorber 18. Any light which passes between granules (or between fins, pores or other structures formed by absorber 18) will generally strike another granule within transparent tubes 14. Moreover, any small amount of light not absorbed at the first incidence on absorber 18 will be absorbed on subsequent incidences within absorber 18. Further, thermal re-radiation in the infrared spectrum, a critical issue with surface-type absorbers, is reduced by the granular structure, as thermal (black body) radiation from sides of the granules that are not facing transparent tubes 14 will also generally strike another granule. Effectively, thermal re-radiation takes place only from the outer perimeter of absorber 18, which has a much smaller surface area than the light-absorbing and liquid-contacting surface areas of absorber 18. Therefore, the granular structures shown in FIGS. 6A and 6B, provide an optically efficient absorber that also transfers heat efficiently and minimizes losses. The granule size can be non-uniform to pseudo-randomize the optical paths through the absorbing material 14, or may be uniform.

While absorber 18 of FIGS. 6A and 6B is a granular structure in accordance with one embodiment of the present invention and provides high efficiency, other light-trapping thermally conductive structures may be used, as long as the liquid or aerosol can flow through transparent tubes 14. One such alternative structure is a sponge-like structure, in which porosity is provided for conducting the liquid or aerosol, while still providing an external surface that can trap incident light. The sponge-like structure is substantially continuous as opposed to the granules, although it may be provided in pieces smaller than the entire length of transparent tubes 14. As mentioned above, absorber 18 can be coated with or made from a catalyst, which may be a thermo-chemical or photo-chemical catalyst for bio-chemical, thermo-chemical or photo-chemical processes. Another alternative is a structural absorber, such as a black anodized metal or black thermally conductive plastic structure that has multiple fins to increase the optical and contact surface area of absorber 18.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A solar heating apparatus for heating a liquid or aerosol medium, comprising:
a reflective collector having a substantially concave cross-section shaped for concentrating incident light within a substantially cylindrical concentrating region extending along a length of the reflective collector and within the cross-section;
at least one transparent tube having a cross-sectional center substantially disposed at a center of the concentrating region and a length disposed along the length of the reflective collector, through which the liquid or aerosol medium is conducted;
a porous optically absorbing material or structure disposed within the at least one transparent tube, whereby the liquid or aerosol medium is permitted to percolate through the at least one transparent tube; and
a transparent top for covering the reflective collector and sealing the reflective collector at tops of the sides of the cross-section of the reflective collector along a bottom surface of the transparent cover, whereby another liquid medium can be contained within the volume defined between the outer surface of the at least one transparent tube, the concave surface of the reflective collector and the bottom surface of the transparent top.

2. The solar heating apparatus of claim 1, wherein the at least one transparent tube comprises multiple transparent tubes, wherein the reflective collector has multiple concave cross sections extending along the length of the reflective collector, wherein each of the multiple transparent tubes have cross sections located in a region of light concentration within a corresponding one of the multiple concave cross sections and have lengths disposed along the length of the reflective collector.

3. The solar heating apparatus of claim 2, wherein the reflective collector and the transparent top comprise:
a unitary transparent polymeric structure having the concave cross-sections formed on a bottom side thereof and the top formed on a top side thereof; and
a reflective material deposited on the outer surface of the concave cross-sections to form one or more optically reflective surfaces.

4. The solar heating apparatus of claim 1, wherein the at least one transparent tube comprises an elastic material, whereby an increase in pressure within the liquid or aerosol medium or an increase in pressure within the other liquid medium causes the transparent tube to deform.

5. The solar heating apparatus of claim 1, wherein the initial cross section of the at least one transparent tube is elliptical, wherein an increase in pressure within the liquid or aerosol medium causes the cross-section of the at least one transparent tube to become more circular, and wherein an increase in pressure within the other liquid medium causes the ratio between the major and minor axes of the elliptical cross-section to increase.

6. The solar heating apparatus of claim 1, wherein the transparent top has an index of refraction greater than an index of refraction of air and a shaped bottom surface such that when the other liquid medium is in full contact with the bottom surface of the transparent top, the incident light is directed through the top surface into the reflective collector, and when the other liquid medium is displaced by a gas, the incident light is re-directed by the transparent top in directions away from the reflective collector and the at least one transparent tube, whereby the solar heating apparatus is thermally protected by conversion of the other liquid medium to the gas or by drainage of the other liquid medium.

7. The solar heating apparatus of claim 6, wherein the bottom surface of the transparent top comprises a plurality of sub-surfaces tilted with respect to a primary plane of the transparent top at a predetermined angular magnitude.

8. The solar heating apparatus of claim 8, wherein he predetermined angular magnitude is substantially equal to 62 degrees.

9. The solar heating apparatus of claim 1, wherein the liquid or aerosol medium is water.

10. The solar heating apparatus of claim 1, wherein the porous optically absorbing material or structure further comprises a catalytic surface, and wherein the liquid or aerosol medium contains substances involved in a reaction process enhanced by the catalyst and the heating of the liquid medium.

11. The solar heating apparatus of claim 1, wherein the porous optically absorbing material or structure is a granular material comprising a plurality of granules introduced into the transparent tube.

12. A method for manufacturing a solar heating apparatus for heating a liquid or aerosol medium, the method comprising:
extruding a polymeric material to form a collector having multiple collector channels having substantially concave cross-sections disposed along a width of a primary plane of the collector and shaped for concentrating incident light within substantially cylindrical concentrating regions extending along a length of the collector and within the concave cross-sections;
disposing an optically reflective coating on the outer surface of the concave cross-sections to form one or more optically reflective surfaces; and
locating a plurality of transparent tubes for containing an optically absorbent material or structures within the collector channels, such that the plurality of transparent tubes have cross-sectional centers substantially disposed at center of corresponding ones of the concentrating regions and lengths disposed along the length of the collector.

13. The method of claim 12, wherein the extruding further extrudes the transparent tubes, where in the locating is performed by the extruding and the transparent tubes are affixed to the collector along the length of the collector.

14. The method of claim 12, further comprising filling the plurality of transparent tubes with the optically absorbent material or structures.

15. The method of claim 12, further comprising applying a transparent top over the collector, wherein a bottom surface of the transparent top contacts upper surfaces of the multiple concave reflective collector to provide a liquid tight assembly.

16. The method of claim 12, wherein the extruding further extrudes a transparent top covering the collector to provide a unitary structure including the collector and the transparent top.

17. The method of claim 16, wherein the extruding further extrudes a transparent cover above the transparent top and on the opposite side of the transparent top from the collector channels, for forming an air gap between the transparent top and the transparent cover.

18. The method of claim 16, further comprising filling the volumes defined between the outer surfaces of the transparent tubes, the concave surfaces of the reflective collector and the bottom surface of the transparent top with another liquid.

19. The method of claim 18, wherein the polymeric material has an index of refraction greater than an index of refraction of air and a shaped bottom surface such that when another liquid medium is in full contact with the bottom surface of the transparent top, the incident light is directed through the top surface of the transparent top into the reflective collector, and when the other liquid medium is displaced by a gas, the incident light is reflected by the transparent top.

20. The method of claim 19, wherein the bottom surface of the transparent top comprises a plurality of sub-surfaces tilted with respect to a primary plane of the transparent top at a predetermined angular magnitude.

21. The method of claim 20, wherein he predetermined angular magnitude is substantially equal to 62 degrees.

22. A method for heating a liquid or aerosol medium, comprising:
providing a reflective collector having a substantially concave cross-section shaped for concentrating incident light within a substantially cylindrical concentrating region extending along a length of the reflective collector and within the cross-section;
providing at least one transparent tube having a cross-sectional center substantially disposed at a center of the concentrating region and a length disposed along the length of the reflective collector, wherein the at least one transparent tube contains a porous optically absorbing material or structure;
providing the reflective collector with a transparent top and sealing the reflective collector at the ends of the cross-section of the reflective collector at a bottom surface of the transparent top;
introducing another liquid medium within the volume defined between the outer surface of the at least one transparent tube, the concave surface of the reflective collector and the bottom surface of the transparent top; and
conducting the liquid or aerosol medium through the at least one transparent tube.

23. The method of claim 22, wherein the transparent top has an index of refraction greater than an index of refraction of air, and further comprising providing a shaped bottom surface on the transparent top such that when the other liquid medium is in full contact with the bottom surface of the transparent top, the incident light is directed through the top surface into the reflective collector, and when the other liquid medium is displaced by a gas, the incident light is reflected by the transparent top, whereby protection is provided from overheating.

24. A solar heating apparatus for heating a liquid or aerosol medium, comprising:
a thin-wall polymeric optically transparent structure including a substantially planar top surface for admitting light and at least one curved surface for forming a shaped optical reflector for concentrating the light admitted through the top surface; and
a reflective coating disposed on the at least on curved surface for forming the shaped optical reflector.

25. The solar heating apparatus of claim 24, wherein the thin-wall polymeric optically transparent structure further includes at least on transparent tube disposed within the curved surface for accepting an optically absorbing material.

26. The solar heating apparatus of claim 24, wherein the top surface and the curved surface form a closed cross-section, and wherein the solar heating apparatus further comprises end caps for sealing the ends of the thin-wall polymeric optically transparent structure to form a liquid-retaining volume between the top surface and the curved surface.

27. The solar heating apparatus of claim 26, wherein the end caps form manifolds for providing an inlet and outlet for liquid entering and leaving the liquid-retaining volume.
